(19) United States
(12) Patent Application Publication
(10) Pub. No.: US 2008/0126255 A1
(43) Pub. Date: May 29, 2008

(54) INTERACTIVE MEDIA CONTENT DELIVERY SYSTEM AND METHOD

(76) Inventor: Zvi Hersh Goldshtein, Haifa (IL)

Correspondence Address: Naomi Assia Law Offices;C/O Landon IP Inc., Suite 450, 1700 Diagonal Road, Alexandria, VA, 22314, US

(21) Appl. No.: 11/936,485

(22) Filed: Nov. 7, 2007

Related U.S. Application Data
(60) Provisional application No. 60/865,174, filed on Nov. 10, 2006.

(51) Int. Cl. H04L 9/00

(52) U.S. Cl. 705/52

(57) ABSTRACT

A method for delivery of exposed content from a content provider to a user, wherein the method is immediately able to provide the time and location of the exposure, thereby facilitating the identification of the content and subsequent delivery of the content. The method includes perceiving the content by the user and initiating a request by the user for identifying information regarding the content, in which case the user decides to whether to make a purchase based on the identifying information, to have the purchase delivered and to be billed for the purchase. The user request may also be for making a purchase based on the perception, in which case delivery is made of the purchase and the user is billed for the purchase.

### FIELD OF THE INVENTION

The present invention relates generally to systems and methods for handling media content, and more particularly to a system and a method for interactive media content delivery.

### BACKGROUND OF THE INVENTION

Ever heard a groovy tune at a coffee shop or at a bar and didn't know the name of the song or the performer? A client who hears a music clip and is interested in purchasing it, is confronted with two constraints:

The need to know the name of a song and the musician performing.

The need to find the requested song in the online music stores.

In the digital age one frequently encounters items of different media types which are to one's liking, causing one to want to obtain information on the media item, possibly so that one can purchase it.

The music market turned over 30 billion dollars in 2006. Consumers frequently want to own music on the spot. Some 76 percent said that when they heard a track they liked they wanted to own it straight away, according to digital music report 2007. Mobile penetration in most of the European countries, Japan, Korea and Israel the degree of penetration pertaining to cellular phones is over 100%. In North America the rate is 70% penetration.

There has been a trend for some time to listen to music over one's computer, perhaps via the Internet using one's cellphone or stored in an iPod™, as opposed to listening to a CD, as in the past.

Today, in order to identify songs that are being played in entertainment venues a person can use the services of Shazam and Gracenote Companies that operate according to algorithmic sounds, a method that requires these companies to encode and house every song that was ever published. This raises the operation expenses and limits the number of songs that can be identified. In order to identify a song using the abovementioned method the user needs to record 20 seconds of the song. One can also identify songs by using Internet sites that can identify a song according to wording or according to humming; for example the 5Pmusic and Nayio.

In order to provide this information several solutions have been introduced. For example, GB2356270, entitled A Personal Database of Reference Data Related to Broadcasts or Published Information, by Keiichi, A multimedia information management method involves storing program information and references data from information providers, relative to identification data of information receiver. WO0223773 entitled System and Method for Ordering and Delivering Media Content, by Christensen, Electronic transaction system for purchasing media contents, extracts RBDS data signal from broadcast channel and displays information related to extracted signal. US Applic. No. 2003097338 entitled Method and System for Purchasing Content Related Material, by Mankovitch, Purchasing content related material e.g. for e-commerce, where a content access device is configured to receive content material and an item identifier associated with the content material from a provider.

US Applic. No. 2005251455 entitled Method and System for Purchasing Access to a Recording, by Boesen, For example, only a time (in some instances a time and location) and channel information is needed in order to determine the audio event associated with that particular time. Although the present invention contemplates other types of transmissions, such as FM radio transmissions, satellite radio presently provides an ideal platform for the present invention.

FIG. 7 provides a block diagram of one embodiment of the present invention. In FIG. 7, a satellite radio 10 is shown. The satellite radio 10 includes an intelligent control 40. The intelligent control 40 can include a processor, microcontroller, microprocessor, integrated circuit, or other type of intelligent control. Operatively connected to the intelligent control 40 is a display 12 and a satellite receiver 48 for receiving satellite radio signals. The satellite radio includes radio controls 50 which can be used for defining channel presets, changing volume, changing channels, and otherwise controlling radio functions.

US Applic. No. 20070192352A1: Content Metadata Directory Services, by Levy, et al, A routing system e.g. distributed router system, for e.g. wireless phone handset, has directory system that stores association between globally unique identifier of content object and metadata source. U.S. Pat. No. 7,062,528: Method and system for identifying a time specific event, by Deguchi: A time specific event identification system e.g. for TV, radio broadcast, has marker device that scores time stamps and device identification codes which are transmitted to user terminal for determining time information.

U.S. Pat. No. 6,507,727: Purchase and delivery of digital content using multiple devices and data networks, by Henrick: A delivery system for digital entertainment media content has server accessed by user of cell phone to order digital content to be downloaded to e.g. personal computer. US Applic. No. 20070044127A1: System for network and local content access, by Vaysman, A digital media content selecting method involves viewing and scheduling digital media content associated with input identification code. U.S. Pat. No. 6,829,368: Establishing and interacting with on-line media collections using identifiers in media signals, by Meyer, A multi-media object linking method for information technology, involves executing action to return data to player device and to present portion of data to user during or before playback.

WO03049435A3: METHOD FOR TRANSMITTING INFORMATION AND CORRESPONDING TELECOMMUNICATION SYSTEM, by Otto, Transmitting information involves sending information related to time track to switching unit, allocating information transmitted at defined time to displayed video sequence information. DE102005026845A1: Program contents, e.g. music title, acquisition method for e.g. music load, involves transmitting content from server of host to internet supported terminal after positive server request with host and activation of control signal, by Zalan. WO03043001C1: LOW COST DISTRIBUTION SYSTEM FOR MUSIC AND OTHER DIGITAL DATA, by Martin, A distribution system for music and other digital data that provides content protection and also records the identify of users or organizations who distribute content on the physical media used e.g., CD.

All the above are included by reference.

### SUMMARY OF THE INVENTION

Accordingly, it is a principal object of the present invention to provide an automatic system for purchasing/downloading/storing digital media/data, such as music, video, speech or any other content to which a user is exposed.

It is a further principal object of the present invention to handle all of the music acquisitions that are made by customers as a result of hearing background music in public places.

It is one other principal object of the present invention to provide the ability to recognize and purchase music that is played in public places in the most convenient way.

It is still a further principal object of the present invention to satisfy the user's need to know the title of the playing content he encounters and/or the name of the artist who wrote or preformed the playing content (hereinafter “the identifier”).

It is another principal object of the present invention to provide a system and a method for purchasing content that saves time, since it is done immediately and in a user-friendly way.

A method is disclosed for delivery of exposed content from a content provider to a user, wherein the method is immediately able to provide the time and location of the exposure, thereby facilitating the identification of the content and subsequent delivery of the content. The method includes perceiving the content by the user and initiating a request by the user for identifying information regarding the content, in which case the user decides to whether to make a purchase based on the identifying information, to have the purchase delivered and to be billed for the purchase. The user request may also be for making a purchase based on the perception, in which case delivery is made of the purchase and the user is billed for the purchase. The geographic location can be retrieved from the IP address of the user's computer, PDA, etc., or from the cellular ID of the user's cellphone by triangulation or GPS.

A system is disclosed for delivery of exposed content from a content provider to a user, wherein the system is able to provide the time and location of the exposure, thereby facilitating the identification of the content and subsequent delivery of the content.

In one possible embodiment the content provider is the owner of the entertainment place where the exposure occurs.

Based on the user's location and the time the massage (request for purchasing) was sent, a remote server detects the content that the user was exposed to (hereinafter “demanded content”).

The demanded content is purchased with no regard to former knowledge about the content identifier, as mentioned above.

After detecting the demanded content the server sends it to the user's PC, mobile phone or any other device which can store the demanded content.

### ADVANTAGES OF THE INVENTION

Purchasing the media can be done immediately and with no regard or knowledge of the media's properties, such as the name of the song/video artist/performer, etc.

The user does not need to do a self search and/or surf through the internet and/or go to a music store in order to purchase a content, all he need to do is being at a place that manage a log regarding the exposed content, to like the content he is exposed to and press on the agreed key/number. The minute the users do so, the invention knows which content to send to the user's PC, mobile phone etc.—the purchase process is done.

The system of the present invention creates a new, friendly and easy way for purchasing contents.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1a is a schematic illustration graphically mapping the comparison of competitive advantages of various prior art providers for convenience for use against identifying precision relative to the present invention;

FIG. 1b is a schematic illustration of an automatic system for purchasing digital media, such as, music, video or speech to which a user may have been exposed, constructed in accordance with the principles of the present invention;

FIG. 2 is a flowchart of an automatic method for purchasing digital media, such as, music, video or speech to which a user may have been exposed, constructed in accordance with the principles of the present invention; and

FIG. 3 is a schematic flow diagram of an automatic method for identifying/purchasing digital media, such as, music, video or speech to which a user may have been exposed, constructed in accordance with the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

This disclosure describes a method and a system for ordering/purchasing and delivering media content.

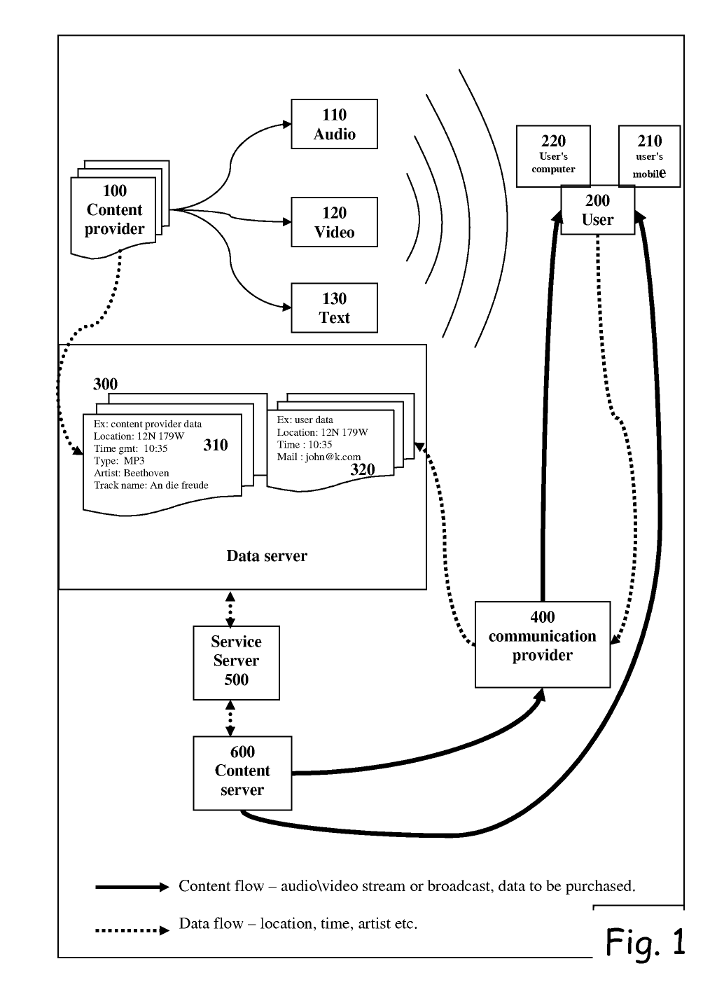

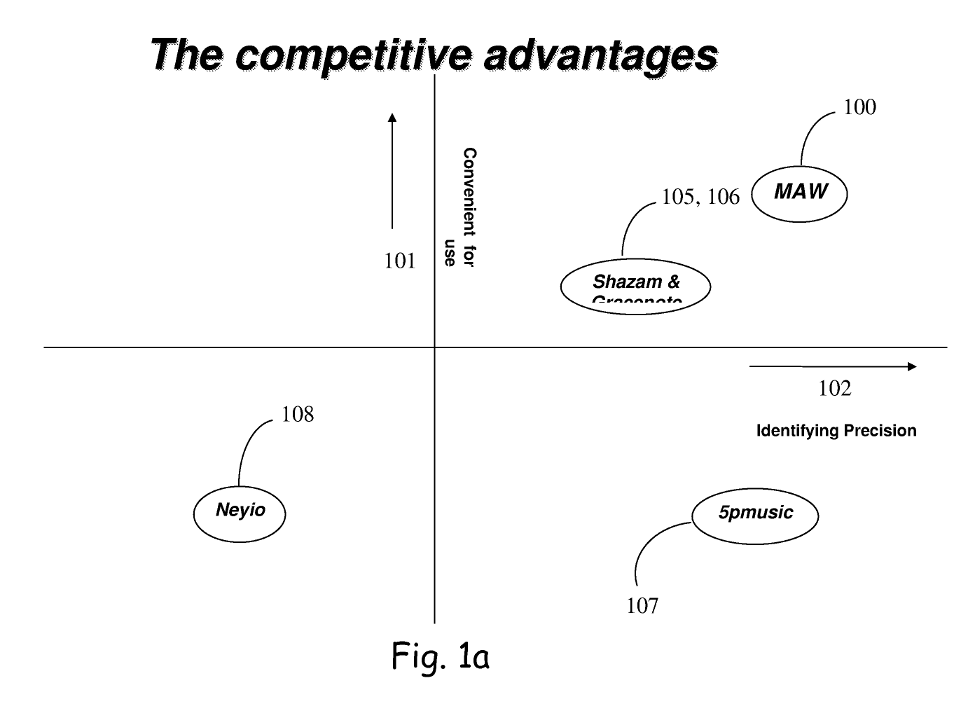

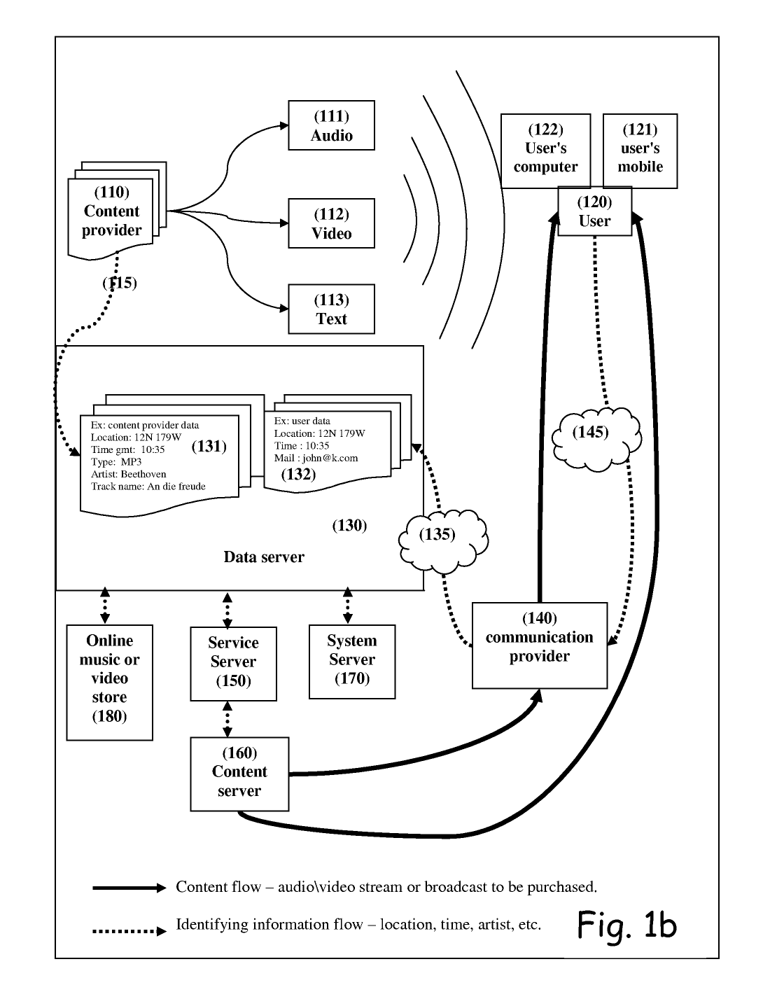

Reference is made to FIG. 1a, which is a schematic illustration graphically mapping the comparison of competitive advantages of various prior art providers for convenience for use 101 against identifying precision relative 102 to the present invention 100 for identifying digital media, such as, music, video or speech to which a user may have been exposed in a coffee shop, restaurant, bar or fitness club, for example. Prior art providers depicted include Shazam 105, Gracenote 106, 5 pmusic 107 and Neyio 108.

FIG. 1b is a schematic illustration of an automatic system for identifying/purchasing digital media, such as, music, video or speech to which a user may have been exposed, constructed in accordance with the principles of the present invention.

A data server 130 located at the content provider 110 site, a remote site or both manages the data regarding the attributes of the exposed content 132 such as: displaying time, displaying duration, performer and geographic location where the content was displayed. The content may be audio 111, video 112, text 113 or an advertisement and is identifying information is constantly being refreshed 115.

The parameters of information and/or purchasing request 132, such as: sending time of the purchasing request; geographic location, as derived by the user's communication provider 140 via a cellphone communications network 145 or WIFI, for example, and passed on to data server 130 via the Internet 135; and destination for the requested content to be sent, e.g., cell phone, home address or e-mail. These parameters can be accessed via automatic SMS by having the user 120 push a single button on his cellphone. The information can be received from Google Earth, from content provider 110 or from a system server 170.

Both purchasing requests and the information regarding exposed contents 132 can be accessed by the service server 150. Service server 150 determines by crosschecking which content is the desired one, then it send the content's attributes, such as artist name and song title to a content server 160 that transmits the desired content to the Email of the user 120 on his computer 122 or to his cellular phone 121 or to any other device which can store the desired content. Information 132 is then automatically retrieved by the data server database 131. Information and content can also be supplied by an online music or video store 180. I-Tunes is an Apple™ music chain, which provides music downloadable mostly for iPods™. There are approximately 500 such online music stores around the world.

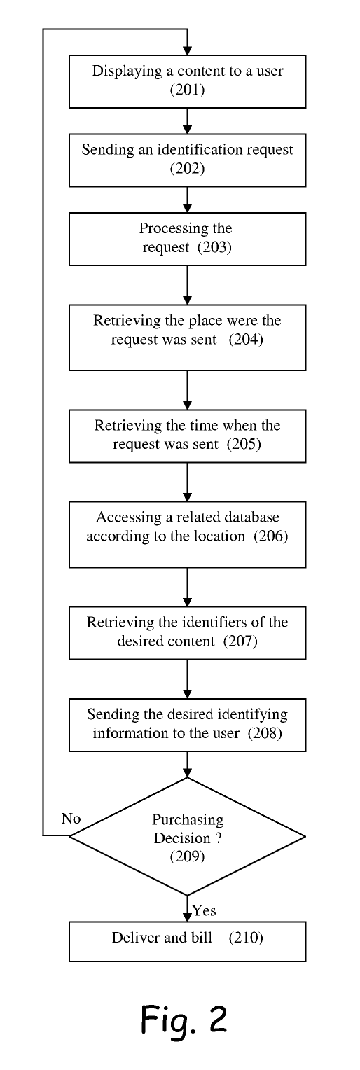

FIG. 2 is a flowchart of an automatic method for identifying and purchasing digital media, such as, music, video or speech to which a user may have been exposed, constructed in accordance with the principles of the present invention. First a user is exposed to content 201. Then the user makes an identification request and sends the request 202. The system then processes the request 203.

The system then retrieves the place from were the request was sent 204 and retrieves the time when the request was sent 205. The system then accesses a related database according to the location 206, retrieves the identifiers of the desired content 207 and sends the identifying information to the user 208. Finally, the user decides whether or not to purchase the desired content 209, and if so the system delivers the content to the user and bills the user 210. If the content is an ad, the user may decide to make a purchase. If, for example, the ad is for a concert, the user may purchase a ticket to be sent directly to his mobile phone.

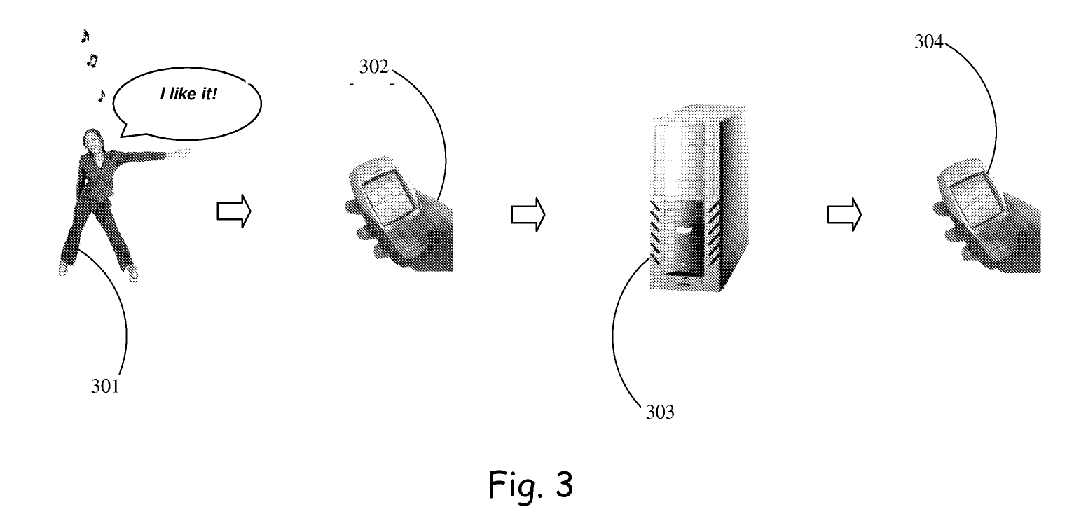

FIG. 3 is a schematic flow diagram of an automatic method for identifying/purchasing digital media, such as, music, video or speech to which a user may have been exposed, constructed in accordance with the principles of the present invention. A mobile phone subscriber hears a song at a venue that plays recorded music 301. The subscriber sends an empty SMS message that is received by the MAW Company servers 302. Such a message is preferably automatically sent via SMS or via WIFI.

Software for automatically sending an SMS message can be downloaded to the subscriber's cellphone. All 3G cellphones have GPS, but if the subscriber phone does not have GPS, the location can be determined by triangulation. The servers of the present invention identify the song by the customer's location and the time the message was sent 303. The name and link of the song are sent to the subscriber, who decides whether to download directly to the subscriber's cellphone or to his e-mail address in general, and to arrange purchase 304.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for delivery of exposed content from a content provider to a user, wherein the method is immediately able to provide the time and location of the exposure, thereby facilitating the identification of the content and subsequent delivery of the content, said method comprising:
perceiving the content by the user;
initiating a request by the user for one of:
identifying information regarding the content, in which case:
deciding whether to make a purchase based on said identifying information, delivering said purchase and
being billed for said purchase; and
a purchase based on said perception, in which case:
delivering said purchase; and
being billed for said purchase.

2. The method according to claim 1, wherein said perceiving the content comprises hearing a song.

3. The method according to claim 1, wherein said perceiving the content comprises perceiving audio/visual content.

4. The method according to claim 3, wherein said audio/visual content comprises an advertisement and said request for a purchase is a result of said ad.

5. The method according to claim 1, wherein said initiating a request comprises sending an SMS message via the mobile phone of the user.

6. The method according to claim 1, wherein said delivering said purchase comprises downloading to the mobile phone of the user.

7. The method according to claim 1, wherein said delivering said purchase comprises downloading to a personal computer of the user.

8. A system for delivery of exposed content information from a content provider to a user, wherein the system is immediately able to provide the time and location of the exposure, thereby facilitating the identification of the exposed content information and subsequent delivery of the content, said system comprising:
a computer with a data server having a database, said database comprising:
content provider information for a plurality of content items, wherein said information is constantly refreshed; and
time and location information received from the user based on a request received from the user;
a service server for cross-checking said time and location information from the user against said content provider information to determine which of said plurality of content items is being referenced by said request; and
a content server to receive transmission of said content provider information from said service provider, and forward said content provider information to the user.

9. The system according to claim 8, wherein said exposed content comprises a song.

10. The system according to claim 8, wherein exposed content comprises audio/visual content.

11. The system according to claim 10, wherein said audio/visual content comprises an advertisement and said request for a purchase is a result of said ad.

12. The system according to claim 8, wherein said initiating a request comprises sending an SMS message via the mobile phone of the user.

13. The system according to claim 8, wherein said delivering said purchase comprises downloading to the mobile phone of the user.

14. The system according to claim 8, wherein said delivering said purchase comprises downloading to a personal computer of the user.

15. The system according to claim 8, wherein said content provider information is forwarded to a mobile phone of the user.

16. The system according to claim 8, wherein said content provider information is forwarded to a personal computer of the user.
